(19) United States
(12) Patent Application Publication
(10) Pub. No.: US 2007/0070463 A1
(43) Pub. Date: Mar. 29, 2007

(54) Image forming apparatus

(75) Inventor: Akihiro Moro, Sunto-gun (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/234,138

(22) Filed: Sep. 26, 2005

(51) Int. Cl. H04N 1/46

(52) U.S. Cl. 358/515; 358/1.13

(57) ABSTRACT

An original determination unit determines a color mode of an original based on image data input from a scanner processing unit. A CPU reads determined information on a color mode determined at the original determination unit, and sets register data into an image processing unit based on the determined information, and further outputs a signal for switching an operation mode to a printer unit based on the determined information. The image processing unit carries out image processing on image data based on the set register data. The printer unit switches a printing operation corresponding to a signal for switching an operation mode, and carries out printing based on the image data on which the image processing has been applied at the image processing unit.

### BACKGROUND OF THE INVENTION

1. Field of the Invention

The present invention relates to an image forming apparatus and an image input method which read a black-and-white or color manuscript, and form a black-and-white or color image.

2. Description of the Related Art

In recent years, because color printers have been marketed by various manufacturers, and product prices are lowered, use of color in documents prepared in offices, and use of color in newspapers, magazines, or the like have progressed. Therefore, the opportunity for utilizing a color digital copier at the time of preparing documents to be distributed in a large number of copies has been increased.

As such a color digital copier, most of the products have, as color modes, a full-color mode in which an original is copied in full color, a black-and-white mode in which an original is made to be and copied in black and white, and an automatic color selection function (ACS) mode in which an original is automatically discriminated and copied as a color manuscript or a black-and-white manuscript.

The ACS mode is a function which is effective when black manuscripts and full-color manuscripts are mixed and copied, in particular, at the time of using an automatic document feeder (ADF). Further, products equipped with a two-color copy function as a picture quality edit function are coming out.

The two-color copy mode is used in large quantity in the home market, and the opportunity has been increased in which, when a two-color manuscript, such as a document submitted to a public office or an office data, on which only counterstamps and the like are in red, is copied, this two-color copy mode is used so as to be charged the same as a black mode in the copy cost aspect.

Further, in Jpn. Pat. Appln. KOKAI Publication No. 10-290363, there is disclosed a technology in which a color balance sensor is provided in an ADF, and the types of manuscripts are categorized into three types of black-and-white, full-color, and red-and-black manuscripts by the color balance sensor. In this technique, the types of manuscripts are looked ahead so as to carry out image processing in a letter mode in the case of a black-and-white manuscript, in an RGB→a red-and-black halftone conversion mode in the case of a full-color manuscript, and in a red-and-black halftone mode in the case of a red-and-black manuscript, which enables to use a high-speed image read using an ADF.

Further, on the other hand, as color digital copiers, there are an engine using a system of four rotations per development unit which is effective as a system for reducing a copy unit cost, and an engine using a one-rotation system in which a development unit is provided for each of the respective colors (Y, M, C, K) (tandem system) with the emphasis on productivity.

In the engine using a four-rotation system, because the throughput is poor, the control is switched between a full-color mode and a black mode, and in a black mode, an image is formed by switching to the one-rotation control.

There are products equipped with an ACS mode and a two-color copy function as described above. In a case of such a product, in an ACS mode, it is automatically determined whether the original is a black manuscript or a full-color manuscript by reading an original, and the processing is switched between a black mode and a full-color mode. In contrast thereto, the two-color copy function is equipped as one of picture edit functions, and is a function of processing an original in two specified colors.

In this way, determination of a two-color manuscript is not carried out in an ACS mode, and an original is not determined at the time of copying in two colors. Therefore, in an ACS mode, the same processing as in a full-color mode is applied onto a two-color manuscript as well. Further, in a case of a two-color copy function, two-color copy processing is applied onto a black-and-white manuscript as well, and a specified printing operation is carried out in two-color copying, and an improvement in throughput regarding black-and-white manuscripts cannot be expected.

### BRIEF SUMMARY OF THE INVENTION

The object of an aspect of the present invention is to provide an image forming apparatus and an image input method in which an attempt can be made to improve productivity by appropriately carrying out determination of a mode using an automatic color selection function.

According to an aspect of the present invention, there is provided an image forming apparatus which reads an image of an original, and forms a black-and-white or color image, the image forming apparatus comprising: reading means for reading an image of an original to output image data; determination means for determining whether the original is a full-color manuscript, a black manuscript, or a two-color manuscript based on color information of the image data output from the reading means; and control means for controlling switching of image processing onto the image data and switching of printing operation in accordance with a determined result of the determination means.

According to another aspect of the present invention, there is provided an image input method which inputs an image of an original comprising: reading an image of an original to output image data; determining whether the image data is a full-color manuscript, a black manuscript, or a two-color manuscript based on color information of the output image data; switching image processing onto the image data in accordance with the determined result; and switching a stored file data format in accordance with the determined result with respect to image data onto which the switched image processing has been applied.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 is a block diagram showing a schematic structure of a color digital copier relating to an image forming apparatus of the present invention;

FIG. 2 is a flowchart for explanation of processing operations of the color digital copier;

FIG. 3 is a flowchart for explanation of processing operations at the time of a two-color copy function;

FIG. 4 is a graph showing an example of histograms which will be a candidate for a black manuscript;

FIG. 5 is a graph showing an example of histograms which will be a candidate for a full-color manuscript; and

FIG. 6 is a graph showing an example of histograms which will be a candidate for a two-color manuscript (a candidate for a red-and-black manuscript).

### DETAILED DESCRIPTION OF THE INVENTION

Hereinafter, an embodiment of the present invention will be described with reference to the drawings.

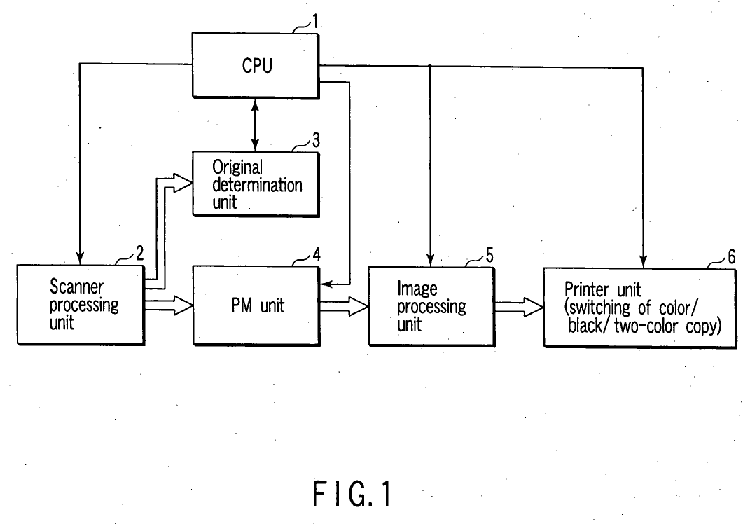

FIG. 1 shows a schematic structure of a color digital copier relating to an image forming apparatus of the present invention. This color digital copier is structured with a CPU 1, a scanner processing unit 2, an original determination unit 3, a page memory (PM) unit 4, an image processing unit 5, and a printer unit 6.

The CPU 1 controls data processing based on user input setting information, display control, and user input conditions from an unillustrated control panel, and the entire apparatus by being connected to the respective units.

The scanner processing unit 2 reads an original by an optical system, and applies shading correction onto data which has been digitized by photoelectric conversion by an unillustrated CCD, and outputs the data as image data in RGB signals to the subsequent stage.

The original determination unit 3 determines an original type based on histogram analysis and color difference levels of the RGB signals from the scanner processing unit 2.

The page memory unit 4 stores the RGB image data from the scanner processing unit 2 in a plurality of pages in units of a page, which can realizes electronic sorting. Further, the page memory unit 4 has an unillustrated compression/extension processing unit, and has a function of controlling storage/read with respect to an unillustrated mass-storage medium such as a hard disk device or the like.

The image processing unit 5 processes image data by switching correction and edit processing in accordance with an original mode or a color mode, and outputs the data to the subsequent stage. Further, the image processing unit 5 is structured with, although not illustrated, a color conversion processing unit, a filter processing unit, an enlargement/reduction processing unit, an inking processing unit, a γ correction unit, and a gradation processing unit, and can change the picture quality by switching the settings for processing operations with respect to the registers for the respective processings.

The printer unit 6 carries out printing operations while switching controls in accordance with a color mode, a black mode, and a two-color copy mode, with respect to the image data processed by the image processing unit 5.

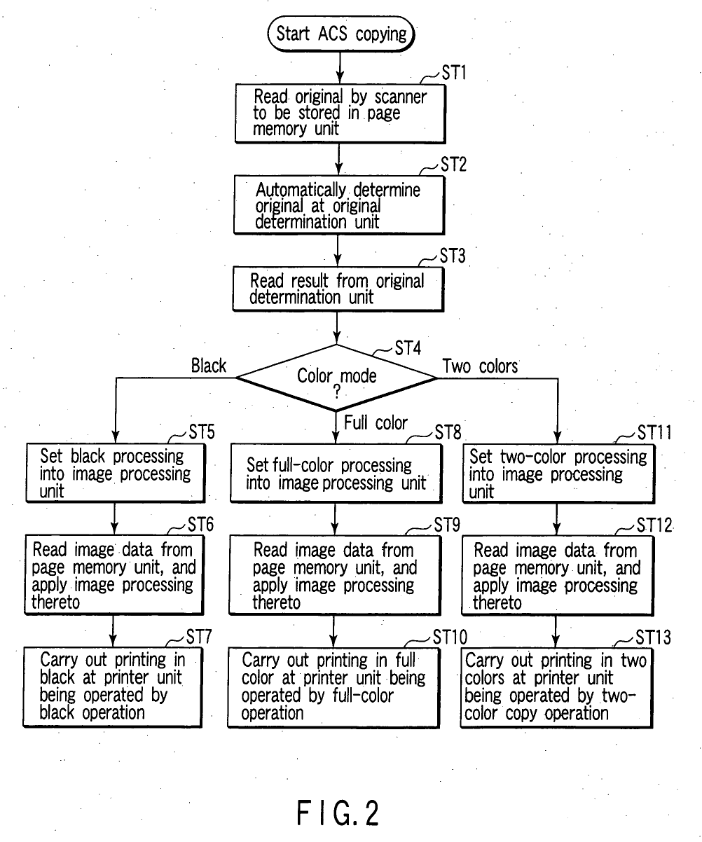

Next, in such a structure, processing operations of the color digital copier will be described with reference to the flowchart of FIG. 2. In the present embodiment, processing is carried out by automatically switching black, full-color, and two-color copy color modes in accordance with a type of an original by using an ACS.

First, an “ACS mode” is selected from an unillustrated control panel. In accordance therewith, the CPU 1 starts ACS copying.

The CPU 1 stores image data (RGB image data) that is read out from an original by the scanner processing unit 2 into the page memory unit 4 (ST1).

Further, the original determination unit 3 determines the original type based on the image data input from the scanner processing unit 2 (ST2). This determination is to determine whether an original is in a color mode of black, full-color, or two-color copying with the help of histogram information and color difference level information. The details of the original determination unit 3 will be described later.

The CPU 1 reads determined information on a color mode determined at the original determination unit 3.

The CPU 1, based on the determined information which has been read (ST4), sets register data which have been arithmetic-processed based on the setting table, which has been prepared in advance, of the processings necessary for the respective color modes, into the image processing unit 5. For example, the data are set in the registers for controlling processing operations with respect to the color conversion unit, the inking unit, the γ correction unit, and the gradation processing unit. The image data in the page memory unit 4 is read, and image processing corresponding to the color mode determination is applied thereto at the image processing unit 5.

Further, the CPU 1 outputs a signal for switching operation mode to the printer unit 6.

At the printer unit 6, printing is carried out by switching between three types of printing operations corresponding to the signal for switching operation mode from the CPU 1.

For example, at the time of four-rotation control in a case of an engine using a system of four rotations per one development unit is as follows.
Black mode: One-rotation control
Full-color mode: Four-rotation control
Two-color copy mode: Two-rotation control or Three-rotation control

Note that, in a case of two-color copying, rotation control is switched corresponding to unillustrated colors specified in advance.

When it is determined as a black mode in step ST4, the CPU 1 sets the processing in a black mode into the image processing unit 5 (ST5). Next, the CPU 1 reads the image data from the page memory unit 4, and applies image processing thereto at the image processing unit 5 (ST6). Then, the CPU 1 controls the printer unit 6 by the black mode operation, and executes printing in black based on the image data on which the image processing has been applied at the image processing unit 5.

When it is determined as a full-color mode in step ST4, the CPU 1 sets the processing in a full-color mode into the image processing unit 5 (ST8). Next, the CPU 1 reads the image data from the page memory unit 4, and applies image processing thereto at the image processing unit 5 (ST9). Then, the CPU 1 controls the printer unit 6 in full-color mode operation, and executes full-color printing based on the image data on which the image processing has been applied at the image processing unit 5 (ST10).

When it is determined as a two-color mode in step ST4, the CPU 1 sets the processing in a two-color mode corresponding to colors set in advance into the image processing unit 5 (ST11). Next, the CPU 1 reads the image data from the page memory unit 4, and applies image processing thereto at the image processing unit 5 (ST12). Then, the CPU 1 controls the printer unit 6 by the two-color copy mode operation corresponding to the colors set in advance, and executes two-color copy printing based on the image data on which the image processing has been applied at the image processing unit 5 (ST13).

Note that, in the present embodiment, it is limited to two-color copying; however, it is possible to extend to correspond to handle a case in which an original is determined as a three-color copying, and the colors are replaced with colors specified in advance, or the like.

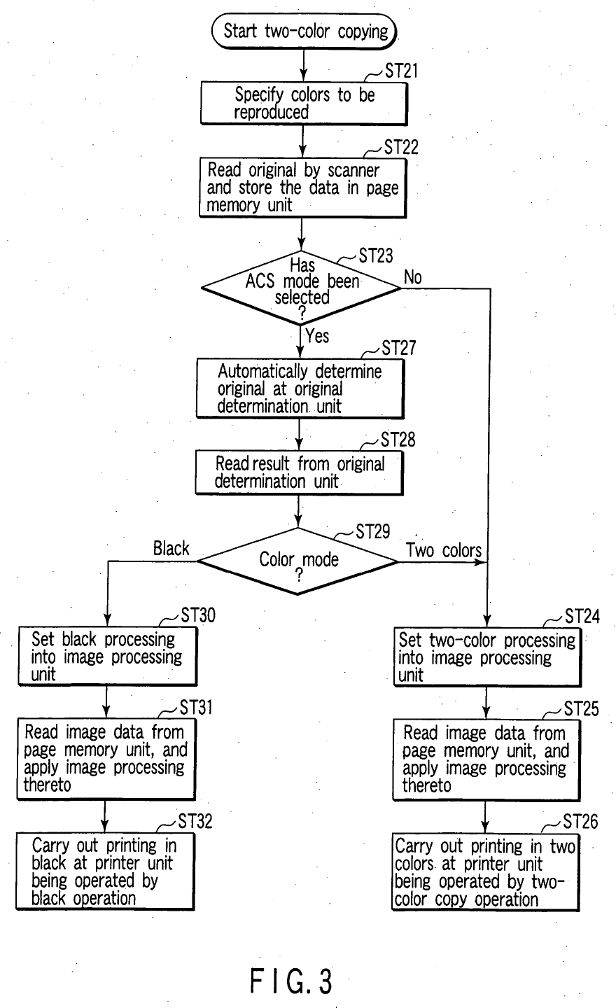

Next, processing operations in a case of a two-color copy function of the color digital copier will be described with reference to the flowchart of FIG. 3. In the present embodiment, in a case of a two-color copy function, processing is carried out by switching black and two-color copy color modes in accordance with a type of an original by using an ACS.

First, “two-color copying” is selected from an unillustrated control panel.

In accordance therewith, the CPU 1 starts two-color copying.

Next, two colors which are colors to be reproduced in two-color copying are selected from an unillustrated control panel (ST21).

The CPU 1 stores image data (RGB image data) that is read out from an original at the scanner processing unit 2 into the page memory unit 4 (ST22).

Next, the CPU 1 determines whether or not an ACS mode is selected (ST23).

When an ACS mode is not selected, the CPU 1 sets register data which have been arithmetic-processed based on the setting table, which has been prepared in advance, for the two-color copy processing into the image processing unit 5 (ST24). For example, the data are set in the registers for controlling processing operations with respect to the color conversion unit, the inking unit, the γ correction unit, and the gradation processing unit.

Next, the CPU 1 reads the image data from the page memory unit 4, and applies image processing thereto at the image processing unit 5 (ST25). Then, the CPU 1 executes two-color copy printing based on the image data on which the image processing has been applied at the image processing unit 5 (ST26).

Further, when an ACS mode is selected in step ST23, the original determination unit 3 determines the original based on the image data input from the scanner processing unit 2 (ST27). This determination is to determine whether an original is in a color mode of black, full-color, or two-color copying with the help of histogram information and color difference level information. The details of the original determination unit 3 will be described later.

The CPU 1 reads determined information on a color mode determined at the original determination unit 3.

The CPU 1, based on the determined information which has been read (ST29), sets register data which have been arithmetic-processed based on the setting table, which has been prepared in advance, of processings necessary for the respective color modes into the image processing unit 5. For example, the data are set in the registers for controlling processing operations with respect to the color conversion unit, the inking unit, the γ correction unit, and the gradation processing unit. The image data on the page memory unit 4 is read, and image processing corresponding to the color mode determination is applied thereto at the image processing unit 5.

Further, the CPU 1 outputs a signal for switching operation mode to the printer unit 6.

At the printer unit 6, printing is carried out by switching between two types of printing operations in accordance with the signal for switching operation mode from the CPU 1.

For example, at the time of four-rotation control in a case of an engine using a system of four rotations in one development unit is as follows.
Black mode: One-rotation control
Two-color copy mode: Two-rotation control or Three-rotation control

Note that, in a case of two-color copying, rotation control is switched corresponding to unillustrated colors specified in advance.

When it is determined as a black mode in step ST29, the CPU 1 sets the processing in a black mode into the image processing unit 5 (ST37). Next, the CPU 1 reads the image data from the page memory unit 4, and applies image processing thereto at the image processing unit 5 (ST31). Then, the CPU 1 controls the printer unit 6 by the black mode operation, and executes printing in black based on the image data onto which the image processing has been applied at the image processing unit 5 (ST32).

When it is determined as a two-color copy mode in step ST29, the CPU 1 executes steps ST24 to ST26.

Additionally, it may be structured such that normal black/full-color, black/full-color/two-color copying, and black/two-color. copying can be selected, and it is possible to switch the operations.

Next, the details of the original determination unit 3 will be described.

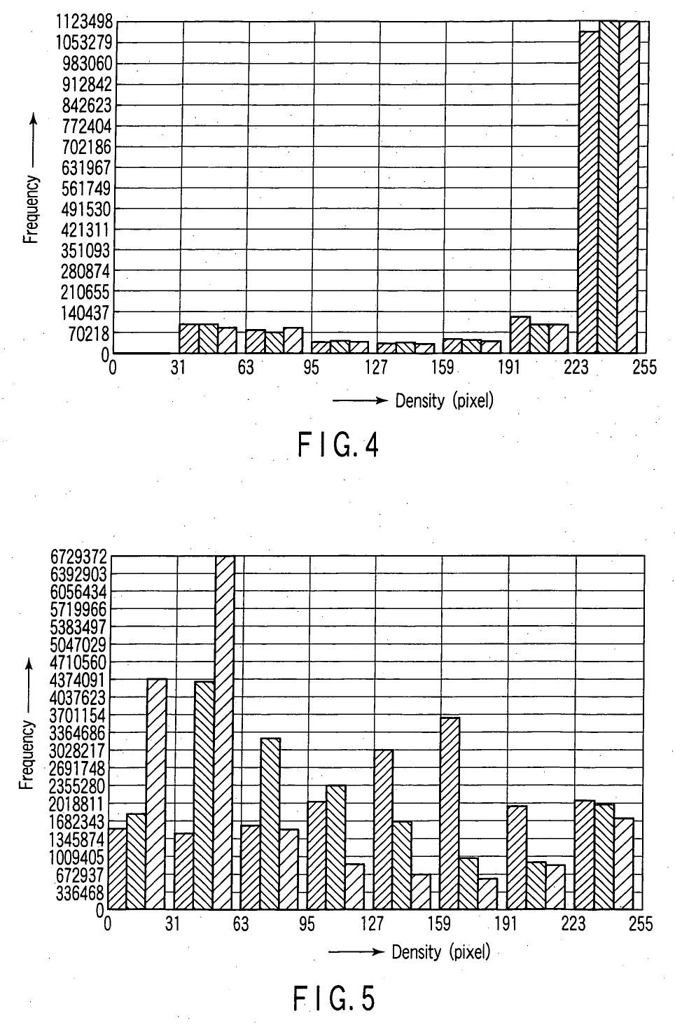

FIGS. 4 to 6 show histogram information and manuscript determination results of the respective manuscripts of the original determination unit 3. Determination of a color mode is carried out by a combination of determinations of histogram analyses and color difference levels. In histograms, density blocks are divided into eight, 0 to 31, 32 to 63, 64 to 95, 96 to 127, 128 to 159, 160 to 191, 192 to 223, and 224 to 255. On the graphs, in the respective density blocks, the upward-sloping line portion (the left side) shows a frequency of red, the downward-sloping line portion (the center) shows a frequency of green, and the upward-sloping rough line portion (the right side) shows a frequency of blue.

In histogram analysis determination, the histogram information on an original are calculated based on color RGB image data from the scanner processing unit 2. As the histograms, frequencies which have been divided into eight for each of RGB with respect to the values of the input image data (from 0 to 256) are calculated. Determination of a type of an original is carried out in accordance with a divided frequency.

Determination of an original is determined in accordance with a variation in frequencies of each of RGB, and a ratio of the frequency of each of the divided regions.

For example, the following determination is carried out. Here, a two-color manuscript is detected as a red-and-black manuscript.

FIG. 4 shows an example of histograms which will be a candidate for a black manuscript. Namely, in a case in which a variation in the frequencies of RGB of each divided region is less than or equal to threshold value A, and a frequency of a divided region at the high density side (eighth division) is greater than threshold value B, and frequencies at the other divided regions are less than threshold value B, the image data is a candidate for a black manuscript.

FIG. 5 shows an example of histograms which will be a candidate for a full-color manuscript. Namely, in a case in which there are a plurality of regions at which a variation in the frequencies of RGB of each divided region is greater than threshold value A, the image data is a full-color manuscript.

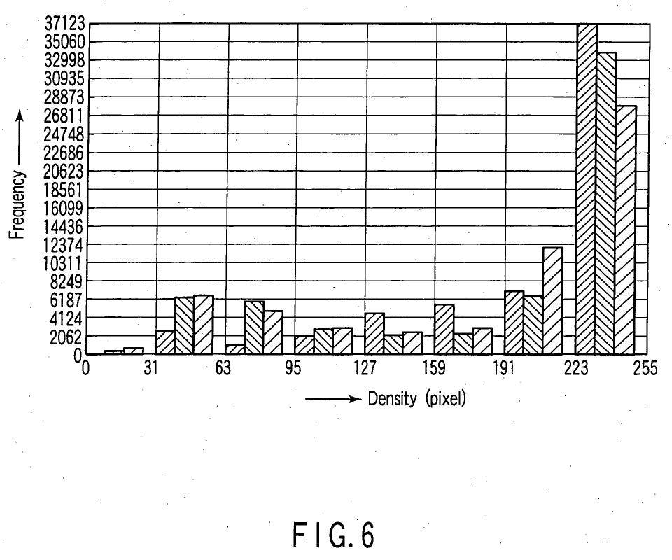

FIG. 6 shows an example of histograms which will be a candidate for a two-color manuscript (a candidate for a red-and-black) manuscript. Namely, in a case in which there are a plurality of regions at which a variation in the frequencies of RGB of each divided region is greater than threshold value C, the image data is a candidate for a two-color manuscript.

On the other hand, with respect to determination of a two-color manuscript by determining color difference levels, the respective color differences in |R-G|, |G-B|, and |B-R| based on the RGB values of the respective pixels of the RGB image data and the respective threshold values THR, THG, and THB are compared with one another, and values CNTR, CNTG, and CNTB that are obtained by counting pixels greater than the threshold values for each color difference are determined.

A counted value that the CNTR, CNTG, and CNTB are summed up, and two-color manuscript determination threshold value THX are compared with one another, and when the counted value is greater than the threshold value THX, the original is determined as a two-color manuscript.

It is determined based on such a combination of histogram analysis determination and color difference level determination.

For example, when it is determined as a candidate for a black manuscript in histogram analysis determination, and when it is determined as a two-color manuscript in color difference level determination, a final manuscript determination is determined as a two-color manuscript giving priority to the color difference level determination.

Further, as a varied example, in a case of handling an original other than a red-and-black manuscript by two-color manuscript determination, it may be a method in which, for each of the color difference counts CNTR, CNTG, and CNTB, the data may be divided by comparing a counted value and a threshold value in a combination corresponding to the colors to be determined.

Further, the examples with respect to copying have been described. However, the present invention can be applied to operations at the time of network scanning.

As described above, in accordance with the embodiment of the present invention, when determination of colors is carried out in a case of ACS mode processing, by adding processing for determining whether an original is in a full-color mode or a two-color copy mode, it is possible to control the contents of image processing and the printing operation so as to automatically switch to a processing mode of a black mode, a full-color mode, or a two-color copy mode based on image data information read from an original.

Further, when a two-color copy function is equipped as one of picture edit functions separately from a color mode, printing operation is carried out by applying two-color processing in a specified color mode. However, when a combination with an ACS mode is made available, it is possible to switch the contents of image processing and the printing operation by determining an original at the time of operating the two-color copy function.

Further, in copying by determination of an original of the present invention, it is possible to reduce the quantity consumed of expendable supplies at the time of copying by switching printing operations, and an exchange timing can be made longer as a unit of expendable supplies whose quantity consumed is little, which enables a reduction in copying cost.

Further, in a four-rotation system color digital copier, it is possible to improve a copy speed by an original to be copied.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus which reads an image of an original, and forms a black-and-white or color image, the image forming apparatus comprising:
reading means for reading an image of an original to output image data;
determination means for determining whether the original is a full-color manuscript, a black manuscript, or a two-color manuscript based on color information of the image data output from the reading means; and
control means for controlling switching of image processing onto the image data and switching of printing operation in accordance with a determined result of the determination means.

2. The image forming apparatus according to claim 1, wherein the determination means determines whether the original is a full-color manuscript, a black manuscript, or a two-color manuscript based on a combination of determination by histogram information and determination by color difference information in the color information of the image data.

3. The image forming apparatus according to claim 2, wherein the determination by color difference information determines the original as a two-color manuscript when respective color differences in |R-G|, |G-B|, and |B-R| based on RGB values of respective pixels of the image data are compared with respective threshold values THR, THG, and THB, and values CNTR, CNTG, and CNTB that are obtained by counting pixels greater than the threshold values are determined for each color difference, and a counted value that is obtained by summing up the CNTR, CNTG, and CNTB is compared with two-color manuscript determination threshold value THX, and the counted value is greater than the threshold value THX.

4. The image forming apparatus according to claim 1, having an engine using a system of four rotations per one development unit.

5. An image forming apparatus which reads an image of an original, and forms a black-and-white or color image, the image forming apparatus comprising:
setting means for setting a two-color copy function as a picture quality edit function;
reading means for reading an image of an original to output image data; and
determination means for determining whether the original is in a black mode or in a two-color copy mode based on color information of the image data output from the reading means when the two-color copy function is set by the setting means.

6. The image forming apparatus according to claim 5, wherein the determination means determines whether the original is in a black mode or in a full-color mode when the two-color copy function is not set by the setting means.

7. The image forming apparatus according to claim 5, further comprising control means for controlling switching of image processing onto the image data and switching of printing operation in accordance with a determined result of the determination means.

8. The image forming apparatus according to claim 7, wherein the control means controls switching of a processing operation and a stored file data format at the time of network scanning in accordance with a determined result of the determination means.

9. An image input method which inputs an image of an original comprising:
reading an image of an original to output image data;
determining whether the image data is a full-color manuscript, a black manuscript, or a two-color manuscript based on color information of the output image data;
switching image processing onto the image data in accordance with the determined result; and
switching a stored file data format in accordance with the determined result with respect to image data onto which the switched image processing has been applied.

10. The image input method according to claim 9, wherein
the switching of a stored file data format is resolution conversion or a change in a number of bits.
